(19) United States
(12) Patent Application Publication
(10) Pub. No.: US 2024/0422844 A1
(43) Pub. Date: Dec. 19, 2024

(54) ADDRESSING BLOCKING ISSUES IN NEXT GENERATION WIRELESS NETWORKS

(71) Applicant: Samsung Electronics Co., Ltd., Suwon-si (KR)

(72) Inventors: Peshal Nayak, Plano, TX (US); Boon Loong Ng, Plano, TX (US); Vishnu Vardhan Ratnam, Plano, TX (US); Rubayet Shafin, Allen, TX (US); Yue Qi, Plano, TX (US); Elliot Jen, Taipei City (TW)

(21) Appl. No.: 18/731,110

(22) Filed: May 31, 2024

Related U.S. Application Data
(60) Provisional application No. 63/521,275, filed on Jun. 15, 2023.
(60) Provisional application No. 63/542,007, filed on Oct. 2, 2023.

(51) Int. Cl. H04W 76/15; H04L 1/1607; H04W 60/04

(52) U.S. Cl. CPC H04W 76/15; H04L 1/1642; H04W 60/04

(57) ABSTRACT

A first device associated with a second device in a wireless network, the first device comprising: at least one station (STA) affiliated with the first device, a processor coupled to the at least one STA, the processor configured to establish one or more links between the first device and the second device, transmit one or more physical layer protocol data units (PPDUs) comprising a plurality of frames to the second device, and receive a first frame from the second device that includes information on a second frame that is missing.

### CROSS-REFERENCE TO RELATED APPLICATIONS

This application claims the benefit of priority from U.S. Provisional Application No. 63/521,275, entitled “Addressing Head of the Line Blocking Issue in Next Generation Wi-Fi Networks” filed Jun. 15, 2023, and to U.S. Provisional Application No. 63/542,007, entitled “Setup Procedure for Out of Order Delivery in Next Generation Wi-Fi Networks” filed Oct. 2, 2023, all of which are incorporated herein by reference in their entirety.

### TECHNICAL FIELD

This disclosure relates generally to a wireless communication system, and more particularly to, for example, but not limited to, addressing head of line blocking in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a first device associated with a second device in a wireless network. The first device comprises at least one station (STA) affiliated with the first device and a processor coupled to the at least one STA. The processor is configured to establish one or more links between the first device and the second device. The processor is configured to transmit one or more physical layer protocol data units (PPDUs) comprising a plurality of frames to the second device. The processor is configured to receive a first frame from the second device that includes information on a second frame that is missing.

In some embodiments, the STA is an access point (AP) STA or a non-AP STA.

In some embodiments, the processor is further configured to transmit the second frame that is missing to the second device.

In some embodiments, the processor is further configured to transmit a next set of frames in a transmit queue to the second device instead of retransmitting the second frame that is missing.

In some embodiments, the first device comprises at least two STAs affiliated with the first device, wherein the processor is configured to establish at least two links between the first device and the second device.

In some embodiments, the first frame is received on a first link between a first STA affiliated with the first device and a first STA affiliated with the second device and the second frame is transmitted on a second link between a second STA affiliated with the first device and a second STA affiliated with the second device.

In some embodiments, the first frame and the second frame are received and transmitted on a same link.

In some embodiments, the first frame and the second frame are received and transmitted on different links.

In some embodiments, the second frame includes a field indicating a link identifier (ID) of a link for which the second frame corresponds to.

In some embodiments, two or more PPDUs are separated by a first interframe space (IFS) that is longer than a short interframe space (SIFS).

One aspect of the present disclosure provides a first device associated with a second device in a wireless network. The first device comprises at least one STA affiliated with the first device and a processor coupled to the at least one STA. The processor is configured to establish one or more links between the first device and the second device. The processor is configured to receive one or more physical layer protocol data units (PPDUs) comprising a plurality of frames from the second device. The processor is configured to identify a first frame that is missing in the one or more PPDUs.

In some embodiments, an STA is an access point (AP) STA or a non-AP STA.

In some embodiments, the processor is further configured to transmit, to the second device, a second frame that includes information on the first frame that is missing in the one or more PPDUs.

In some embodiments, the processor is further configured to receive the first frame from the second device.

In some embodiments, the processor is further configured ignore the first frame and transmit the plurality of frames to an upper layer within the first device.

In some embodiments, the first device comprises at least two STAs affiliated with the first device, wherein the processor is configured to establish at least two links between the first device and the second device.

In some embodiments, the second frame is transmitted on a first link between a first STA affiliated with the first device and a first STA affiliated with the second device and the first frame is received on a second link between a second STA affiliated with the first device and a second STA affiliated with the second device.

In some embodiments, the first frame and the second frame are received and transmitted on a same link.

In some embodiments, the first frame and the second frame are received and transmitted on different links.

In some embodiments, two or more PPDUs are separated by a first interframe space (IFS) that is longer than a short interframe space (SIFS).

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates an example of a hole in the SN/PN window due to a missing frame.

FIG. 5 illustrates a format of a control subfield variant of an A-control subfield in accordance with an embodiment.

FIG. 6 illustrates usage of an A-control subfield in accordance with an embodiment.

FIG. 7 illustrates a control frame format for HOL blocking signaling in accordance with an embodiment.

FIG. 8 illustrates a missing frame info subfield format in accordance with an embodiment.

FIG. 9 illustrates usage of an individually addressed control frame for addressing HOL blocking issue in accordance with an embodiment.

FIG. 10 illustrates an A-control subfield format in accordance with an embodiment.

FIG. 11 illustrates an example when a non-AP MLD cannot transmit a missing frame in accordance with an embodiment.

FIG. 12 illustrates same link signaling and recovery in accordance with an embodiment.

FIG. 13 illustrates a head of line (HOL) interframe space separation based same link signaling and recovery in accordance with an embodiment.

FIG. 14 illustrates missing frame payload insertion based on PPDU end marker in accordance with an embodiment.

FIG. 15 illustrates missing frame payload transmission following the end of current payload transmission in accordance with an embodiment.

FIG. 16 illustrates a negotiation request element frame format in accordance with an embodiment.

FIG. 17 illustrates an indication via an A-control subfield in accordance with an embodiment.

FIG. 18 illustrates a flow chart of an example process for request message transmission in accordance with an embodiment.

FIG. 19 illustrates a flow chart of a process for response message transmission in accordance with an embodiment.

FIG. 20 illustrates a flow chart of an example process of unsolicited authorization message in accordance with an embodiment.

FIG. 21 illustrates a flow chart of a process for unsolicited indication message in accordance with an embodiment.

FIG. 22 illustrates a flow chart of a process of capability advertisement in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11bc. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

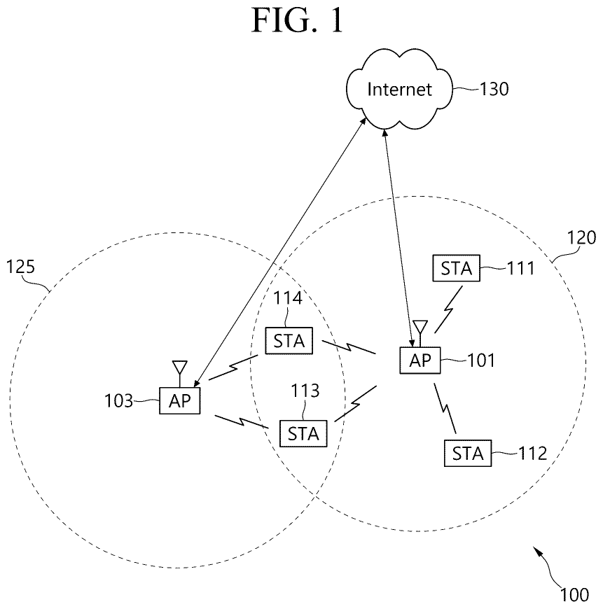

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

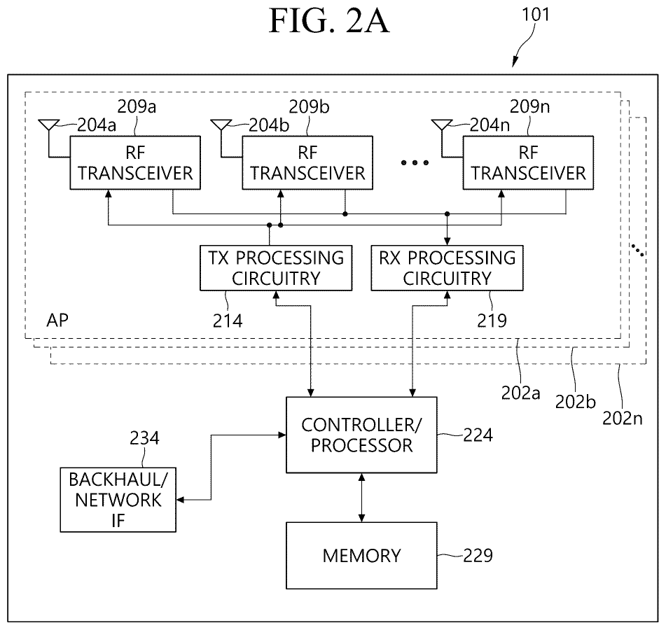

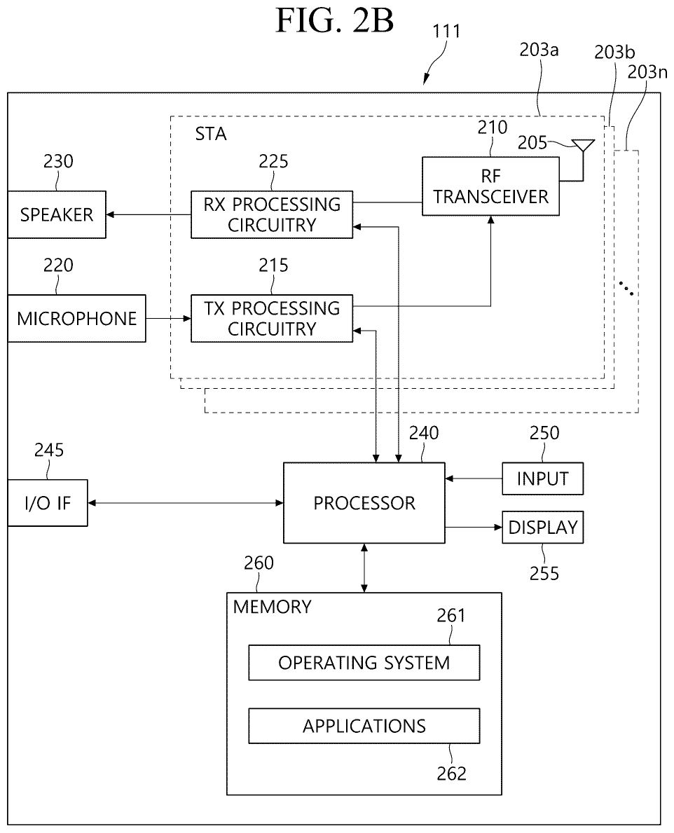

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

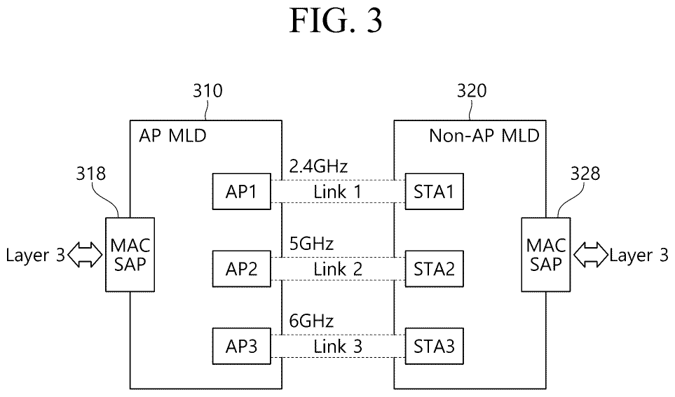

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications” and ii) IEEE P802.11bc/D3.2, “Wireless LAN Medium Access Control (MAC) and Physical Layer (PHY) Specifications.”

IEEE 802.11 MAC is designed to deliver frames in-order to higher layers. To this end, the MAC at the transmitter assigns sequence numbers to transmitted frames, for example, MAC Service Data Unit (MSDU), Aggregated-MSDU (A-MSDU), Management MAC Protocol Data Unit (MMPDU), among others. The MAC header includes sequence control information in the sequence control field. This field includes the sequence number assigned by the transmitter. This is a 12-bit field that can allow the sequence number to take values from 0 to 4095. The transmitter assigns sequence numbers starting from 0 and increments them for each successive frame by 1. This allows the receiver to identify the order of the transmitted frames and perform in order delivery. Thus, at the receiver side, a receive reorder buffer holds the frames and passes them, in order, to a higher layer. Such an in-order delivery benefits applications where in-order delivery is desirable. Unfortunately, this behavior may also cause a head of the line (HOL) blocking issue. The issue arises when a particular frame is not received due to any reason (e.g., frame going in error, among others) but a frame with a higher sequence number is received correctly, which may thereby cause a hole in the sequence number. Due to the hole in the sequence number, a frame can get held in a reorder buffer and thus may not be transmitted to a higher layer until the hole is filled up. This can cause an additional delay to frames.

The delay can hinder performance especially when the frame that is facing a HOL blocking issue belongs to a low latency traffic stream. For example, suppose that a STA affiliated with a non-AP MLD is transmitting frames that belong to multiple traffic streams with different requirements (e.g., different stream classification service (SCS) setups, among others) but mapped to the same traffic identifier (TID). Suppose that a hole in the sequence number is created causing a HOL blocking issue and there is a high priority/urgent traffic frame that belongs to the same TID. The HOL blocking issue can further worsen the delays faced by the frame.

The HOL blocking issue can also hinder the performance of features which may be designed for latency reduction (e.g., preemption, among others). For example, suppose that the transmitter performs preemption in the same transmission opportunity (TXOP) and transmits a physical layer protocol data unit (PPDU) of a latency sensitive traffic which maps to the same TID as the one where a HOL blocking issue is being faced at the receiver side. The preemption attempt of the transmitter can become less effective by the additional delay. Several examples of HOL problems are described below.

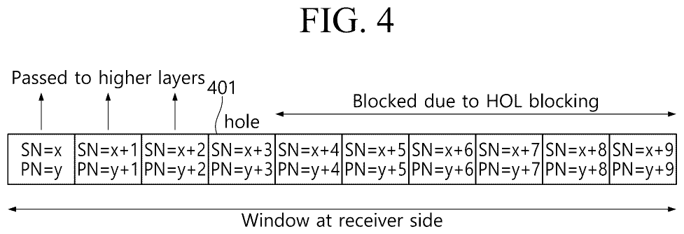

Example 1: Suppose that a transmitter is sending frames and a particular frame goes missing due to, for example, errors in reception but frames with higher sequence/packet numbers are received correctly. FIG. 4 illustrates an example of an HOL problem with a missing frame in accordance with an embodiment. As illustrated in FIG. 4, the missing frame can result in a hole 401 in the sequence which needs to be filled in with a retransmission from the transmitter side. It is possible that the frames that are received with higher numbers can face a delay due to HOL blocking until the frames with higher sequence/packet numbers are received. In particular, FIG. 4 illustrates an example of a hole in the sequence number (SN)/packet number (PN) window due to a missing frame. The SN starts at x and the PN starts at y, where SN for subsequent frames is denoted as x+1, x+2 . . . x+9, and PN for subsequent frames are denoted as y+1, y+2 . . . y+9, and which frames are passed to higher layers. However, there is a hole 401 at frame SN=x+3 and PN=y+3. Accordingly, the remaining frames, from SN=x+4 to x+9 and PN=y+4 to y+9 and on are blocked due to the HOL blocking.

Example 2: The hold can be created by an earlier transmission (e.g., a frame missed from an earlier transmission due to reasons such a reception errors, among others). It is possible that the receiver tries to re-send the frame but after many attempts is unable to do so. Higher sequence/packet number frames may arrive at the transmitter and thus face a HOL blocking until a timer to consider the hole unreplaceable by the MAC expires and the frames are passed to higher layers.

Example 3: The transmitter can interrupt an ongoing transmission to send a frame with a different traffic identifier (TID) as a part of a network capability (e.g., preemption, quality of service priority, among others). Thus, a different TID frame can get transmitted in an ongoing transmission with a higher priority. It can happen that the frame that is transmitted can face a hole in sequence number at the receiver.

Some embodiments of the disclosure provide a framework for handling HOL blocking issues in next generation wireless networks, thereby reducing latencies while supporting high reliability. Some embodiments provide a framework for addressing HOL blocking when maintaining in-order delivery.

In some embodiments, HOL blocking may be addressed by filling up the hole in the sequence number at a faster pace. In some embodiments, a receiver can signal to the transmitter that it has a HOL blocking issue and request the transmitter to fill up the hole (e.g., by transmitting the missing frame). When the transmitter and the receiver are MLDs, this signaling can be done on the same link or on a different link.

In some embodiments, the transmitter may be a non-AP MLD and the receiver may be an AP MLD. During the transmission on a link, e.g., link 1, one of the frames being transmitted by the non-AP MLD may go in error. This can cause a HOL blocking issue. The non-AP MLD can signal to the AP MLD about the HOL blocking issue. Upon receiving such an indication from the non-AP MLD, the AP MLD can transmit the frame causing the hole in the sequence number to address the HOL blocking issue.

In some embodiments, the signaling can be done in a cross-link manner. The AP MLD can signal to the non-AP MLD on one or more of the other links setup between the AP MLD and the non-AP MLD about the HOL blocking issue. Upon receiving such an indication, the non-AP MLD can transmit the frame that causes the HOL blocking issue. The frame can also be transmitted in a cross-link manner.

In order to signal to the non-AP MLD, the AP MLD can transmit a frame that includes at least one or more of the information items as indicated in Table 1.

TABLE 1

| Information item | Description |
|---|---|
| HOL blocking | An information item that can indicate that there is a HOL blocking |
| indication | issue. e.g., this can be a one-bit field which can be set to 1 to indicate |
| | that there is a HOL blocking issue and to 0 to indicate otherwise. The 0 |
| | indication can be useful in scenarios where the frame that goes missing |
| | is at the end of the sequence and succeeding frames have not yet been |
| | received by the AP MLD. |
| Frame information | An information item that can indicate the frame(s) which is causing the |
| | HOL issue. The transmitter needs to transmit this missing frame(s). |
| | This can be done via a single field in the signaling or via multiple |
| | fields. e.g., there can be one field that indicates the starting sequence |
| | number and a bitmap that indicates different frames that are missing |
| | starting from the starting sequence number. |
| Timing | An information item indicating a time limit by which the missing |
| information | frame(s) transmission needs to be done by the transmitter. This can be |
| | a hard requirement or a soft recommendation. |
| Link information | An information item indicating the link on which the missing frame(s) |
| | transmission can be done by the transmitter. e.g., link id bitmap. |
| Reason | An information item that can indicate the reason for making this |
| information | request. e.g., reason code. |
| TID indication | An information item indicating the TID(s) for which the HOL blocking |
| | issue is being faced. |

The above information can be carried in a newly defined frame and/or in any of the existing frames in the standard.

In some embodiments, the signaling can be cross link but the recovery of the frame causing the hold can be done on the same link on which the transmission is going on. The recovery can be done as a part of the ongoing transmission (e.g., in the same TXOP).

In some embodiments, cross link signaling can be done by using a control subfield variant of an A-control subfield.

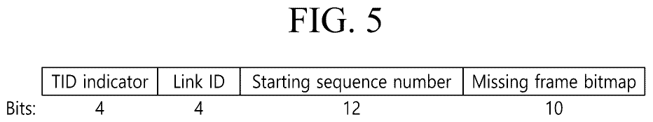

FIG. 5 illustrates a format of a control subfield variant of an Aggregated control (A-control) subfield in accordance with an embodiment. The A-control subfield can include a TID indicator field, a Link ID field, a starting sequence number field, and a missing frame bitmap field.

The TID indicator field can indicate the TID for which this HOL blocking issue is being faced. The Link ID field can indicate the link for which this indication corresponds to. The starting sequence number field can indicate the sequence number of the MSDU which is used as a reference. The missing frame bitmap field can be used to indicate the missing frames which are causing the HOL blocking issue. Each entry can represent an MSDU or an A-MSDU. Each bit that is set to 1 in the bitmap can indicate the missing MSDU or A-MSDU in the order of sequence, with the first bit in the bitmap corresponding to the MSDU or A-MSDU with the sequence that matches the starting sequence number subfield indicated in the starting sequence number subfield.

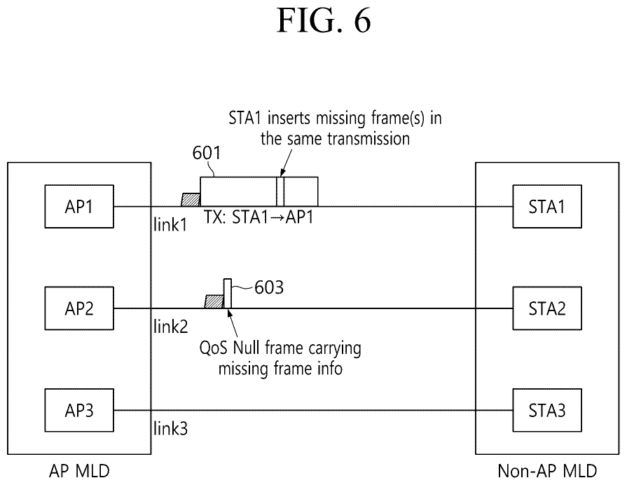

FIG. 6 illustrates usage of an A-control subfield in accordance with an embodiment. As illustrated, there is an AP MLD with three AP STAs, AP1, AP2 and AP3. Non-AP MLD is associated with AP MLD and has three non-AP STAs, STA1, STA2 and STA3. The association results in creation of three links, link1, link2 and link3. STA1 is associated with AP1 on link 1, STA2 is associated with AP2 on link 2, and STA3 is associated with AP3 on link 3. STA1 is transmitting a PPDU 601 to AP1. The transmission may include one or more frames that have a missing frame and can get affected by the HOL blocking issue. In some embodiments, there can also be a HOL blocking issue that may not affect any of the frames in the current transmission but can affect frames in future transmissions. AP2 transmits a frame 603 (e.g., Quality of Service (QoS) null frame) to STA2 to inform STA2 of a missing frame on link 1. In some embodiments, an A-control subfield can be transmitted as a part of an ongoing transmission from AP2 to STA2. Upon receiving the missing frame information, STA1 inserts and transmits the missing frame as a part of the ongoing transmission 601 on link1.

In some embodiments, cross link signaling can be done through an individually addressed control frame instead of an A-control subfield.

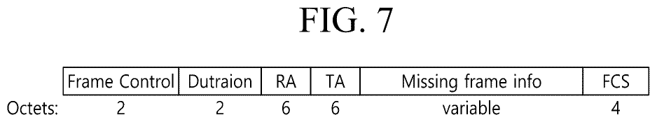

FIG. 7 illustrates a control frame format for HOL blocking signaling in accordance with an embodiment. The control frame format can include a frame control field, a duration field, a receiver address (RA) field, a transmitter address (TA) field, a missing frame info field, and a FCS field. The frame control field may control the frame. The duration field may provide duration information. The RA field may provide a receiver address. The TA field may provide a transmitter address. The missing frame info field can include one or more of the missing frame info subfields. The FCS field may provide information regarding a frame control subfield.

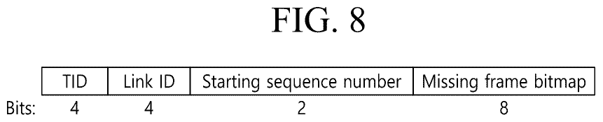

FIG. 8 illustrates a missing frame info subfield format in accordance with an embodiment. The missing frame info subfield format can include a TID field, a link ID field, a starting sequence number field, and a missing frame bitmap field. The TID subfield can indicate the TID for which this information corresponds to. The Link ID field can indicate the link for which this information corresponds to. The starting sequence number field can indicate the sequence number of the MSDU which is used as a reference. The missing frame bitmap field can be used to indicate the missing frames which are causing the HOL blocking issue. Each entry can represent an MSDU or an A-MSDU. Each bit that is set to 1 in the bitmap can indicate the missing MSDU or A-MSDU in the order of sequence, with the first bit in the bitmap corresponding to the MSDU or A-MSDU with the sequence number that matches the starting sequence number subfield indicated in the starting sequence number subfield.

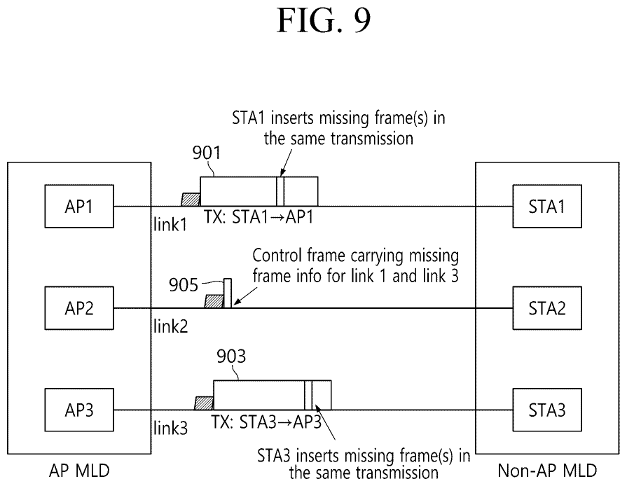

FIG. 9 illustrates usage of an individually addressed control frame for addressing HOL blocking issue in accordance with an embodiment. As illustrated, there is an AP MLD with three AP STAs, AP1, AP2 and AP3. Non-AP MLD is associated with AP MLD and has three non-AP STAs, STA1, STA2 and STA3. The association results in creation of three links, link1, link2 and link3. STA1 is associated with AP1 on link 1, STA2 is associated with AP2 on link 2, and STA3 is associated with AP3 on link 3. STA1 is transmitting frames 901 to AP1. STA3 is transmitting frames 903 to AP3. The transmissions may include one or more frames that have missing frames and can get affected by the HOL blocking issue. In some embodiments, there can also be a HOL blocking issue that may not affect the frames in the current transmission but can affect frames in future transmissions. AP2 transmits an individually addressed control frame 905 to STA2 to inform STA2 of the missing frame information for link 1 and link 3. Upon receiving the information, STA1 transmits the missing frame(s) as a part of the ongoing transmission 901 on link 1 and STA3 transmits the missing frame(s) as a part of the ongoing transmission 903 on link3. In some embodiments, indication can be made via an action frame (e.g., an element carried inside an action frame).

In some embodiments, if the non-AP MLD is unable to transmit the necessary frame to fill the hole for a reason (e.g., if the non-AP MLD has dropped the frame due to, for instance, delay timer getting exceeded, among others), then the non-AP MLD can transmit a frame indicating that it is unable to transmit the necessary frame to the AP MLD. The frame can include at least one or more of the information items indicated in Table 2.

TABLE 2

| Information item | Description |
|---|---|
| Frame | An information item that can indicate the frame(s) which is causing the |
| information | HOL issue and the non-AP MLD is unable to transmit to the AP MLD. |
| | This can be done via a single field in the signaling or via multiple fields. |
| | e.g., there can be one field that indicates the starting sequence number and |
| | a bitmap that indicates different frames that are missing starting from the |
| | starting sequence number. |
| Reason | An information item that can indicate the reason. e.g., reason code which |
| information | can indicate that the reason for not being able to send the frame is that the |
| | frame has been dropped at the non-AP MLD side. |
| TID indication | An information item indicating the TID(s) to which the frame(s) that the |
| | non-AP MLD is unable to transmit belongs to. |

The above information items can be transmitted in a single frame or more than one frame(s). The above information n can be transmitted in a newly defined frame/field/subfield/element and/or in any of the existing frame/field/subfield/element in the standard.

In some embodiments, the STA can include an A-control subfield inside a PPDU transmission to the AP MLD to indicate to the AP MLD that it is unable to transmit the frame that is needed to fill the hole to address the HOL blocking issue.

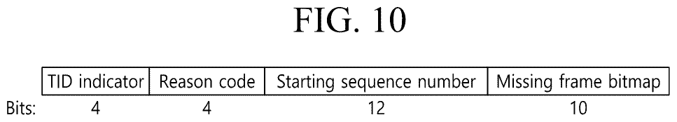

FIG. 10 illustrates an A-control subfield format in accordance with an embodiment. The A-control subfield format can include a TID indicator field, a reason code field, a starting sequence number field, and a missing frame bitmap field.

The TID indicator field can indicate the TID for which the missing frame(s) that the STA cannot transmit corresponds to. In some embodiments, there can be a TID bitmap instead of the TID indicator field. The reason code field can indicate the reason for transmitting the A-control subfield. For example, a value that can indicate that the reason for sending this A-control subfield is to indicate to the AP MLD that the requested frame(s) cannot be transmitted as the non-AP MLD has already dropped them. The starting sequence number field can indicate the sequence number of the MSDU which is used as a reference. The missing frame bitmap field can be used to indicate the missing frames which cannot be transmitted by the non-AP MLD. Each entry can represent an MSDU or an A-MSDU. Each bit that is set to 1 in the bitmap can indicate the missing MSDU or A-MSDU in the order of sequence, with the first bit in the bitmap corresponding to the MSDU or A-MSDU with the sequence number that matches the starting sequence number subfield indicated in the starting sequence number subfield.

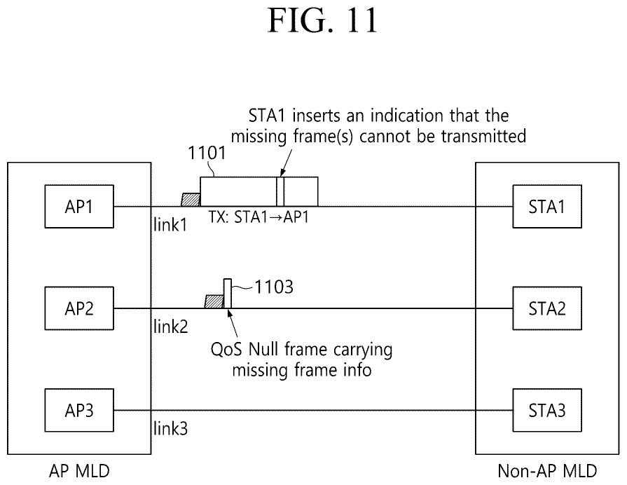

FIG. 11 illustrates an example when a non-AP MLD cannot transmit a missing frame in accordance with an embodiment. In particular, FIG. 11 illustrates AP MLD which includes AP1, AP2, and AP3 and non-AP MLD, which includes STA1, STA2, and STA3. STA1 is associated with AP1 on link 1, STA2 is associated with AP2 on link 2, and STA3 is associated with AP3 on link 3. STA1 has an ongoing transmission 1101 and is transmitting frames to AP1 on link 1. STA2 receives a Quality of Service (QOS) null frame 1103 from AP2 that includes missing frame information. As illustrated, upon receiving the frame 1103 from the AP MLD carrying information on the missing frame(s), STA1 of non-AP MLD determines that it cannot transmit one or more of the frames indicated by the AP MLD. Therefore, STA1 signals to AP1 via the ongoing transmission 1101 about the frames that STA1 cannot transmit to AP1. Upon receiving the indication from STA1, AP MLD can then consider the hole as unfillable by the MAC and pass the frames with higher sequence number to the upper layer. The higher layer protocols (e.g., transmission control protocol (TCP), among others) can then try to retrieve the missing frames based on their operation if possible.

In some embodiments, the indication can also be given in an action frame/individually addressed control frame that is transmitted in response to the AP MLD's request for the missing frame(s).

In some embodiments, indication of the HOL blocking issue can be done in a cross-link manner and the recovery of the missing frame can also be done in a cross-link manner.

In some embodiments, in response to the AP MLD's cross-link signaling, the non-AP MLD can transmit the missing frame in a cross-link manner either in an independent fashion, as a part of an existing frame on a different link, and/or transmitted independently on a different link (e.g., in response to the signaling of the AP MLD on a given link).

When transmitting the frame on a different link, the MAC header of the frame can include a field indicating the link ID of the link for which this transmission corresponds to. The AP MLD can then understand which link the frame was intended to be originally transmitted on.

In some embodiments, the signaling can be done on the same link on which the transmission whose frames can get affected by the HOL block issue is going on or on the same link which is facing the sequence number hole issue.

In some embodiments, the non-AP MLD can divide its PPDU into smaller fragments and each fragment can be acknowledged by the AP MLD. If there is a HOL blocking issue, AP MLD can indicate it in the acknowledgement that it transmits to the non-AP MLD and the non-AP MLD can transmit the missing frame in the succeeding PPDU.

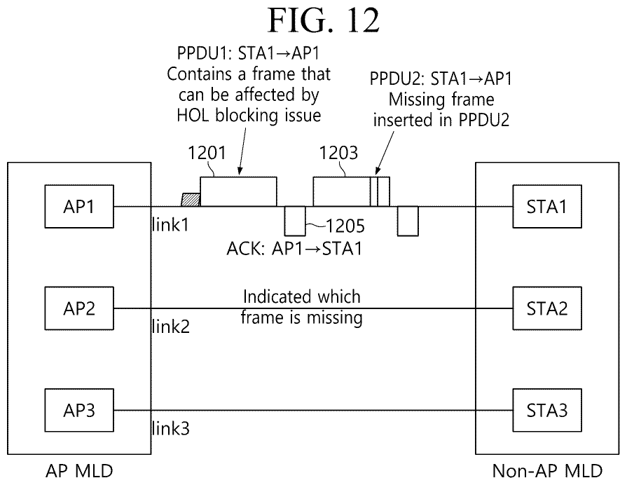

FIG. 12 illustrates same link signaling and recovery in accordance with an embodiment. In particular, FIG. 12 illustrates AP MLD which includes AP1, AP2, and AP3 and non-AP MLD, which includes STA1, STA2, and STA3. STA1 is associated with AP1 on link 1, STA2 is associated with AP2 on link 2, and STA3 is associated with AP3 on link 3. STA1 has an ongoing transmission 1201 and is transmitting frames to AP1 on link 1. As illustrated non-AP, MLD divides a PPDU into smaller fragments that include a PPDU1 1201 and a PPDU2 1203. Each fragment is acknowledged by the AP MLD, where if there is a HOL blocking issue, the AP MLD indicates the HOL blocking issue in the acknowledgement that the AP MLD transmits to the non-AP MLD. As illustrated, STA1 transmits PPDU1 1201 to AP1 which includes a frame that can be affected by HOL blocking issue. As such, AP1 transmits an acknowledgement ACK 1205 to STA1, where the ACK 1205 indicates which frame is missing. As such STA1 transmits PPDU2 1203 to AP1 that includes the missing frame which is inserted into the PPDU2.

In some embodiments, an STA of a non-AP MLD can divide a PPDU into smaller fragments each separated by an interframe space (IFS). In some embodiments, an IFS may be designed specifically for the HOL blocking issue, which may be referred to as an hIFS. If there is a frame that can face an HOL blocking issue, then the AP MLD can interrupt the transmission by transmitting a signaling in the IFS gap instead.

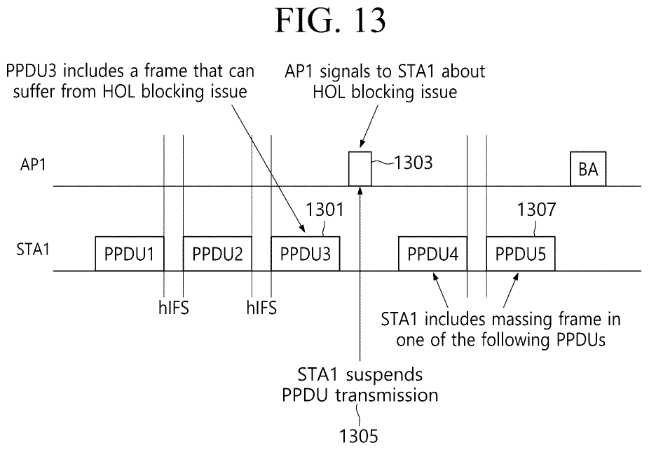

FIG. 13 illustrates hIFS separation based same link signaling and recovery in accordance with an embodiment. In some embodiments, an hIFS may provide an interframe spacing that provides a gap between consecutive PPDUs in a TXOP. Accordingly, if one or more frames in a PPDU experience an error, then an indication of the error can be provided in during the hIFS. As such, based on indication, a transmitter can modify one or more of the following PPDUs to carry the frames that went in error.

In particular, FIG. 13 illustrates communication between AP1 and STA1. As illustrated, when AP 1 interrupts the next PPDU with transmission of a signaling, STA1 can transmit the missing frame in the next PPDU. STA1 has divided its uplink transmission into several PPDUs, including PPDU1, PPDU2, PPDU3, PPDU4, and PPDU5. Each PPDU is separated by hIFS. PPDU3 1301 has a frame that can suffer from HOL blocking issue. Within the hIFS following PPDU3, AP1 transmits within the hIFS duration a frame 1303 to signal to STA1 about the HOL blocking issue. The frame 1303 can be an acknowledgement frame such as block ACK/ACK or can be any of the signaling described herein. Upon receiving the frame 1303, STA1 can include the missing frame in the following PPDUs 1307, such as PPDU4 and/or PPDU5, and transmit the frame to the AP.

In some embodiments, even if the signaling is on the same link the recovery can be done on a different link by tagging the frame(s) with a link ID inserted in the MAC header.

In some embodiments, when an STA includes a missing frame in a following PPDU, it can insert the frame inside the PPDU.

In some embodiments, the STA can interrupt the existing PPDU transmission and insert a new PPDU that includes the missing frame(s).

In some embodiments, the STA can choose to divide a PPDU into multiple PPDU payloads and the physical (PHY) layer can end the transmission at the nearest boundary by inserting a PPDU end marker and insert the PPDU including the missing frame(s) after an IFS following the PPDU end marker.

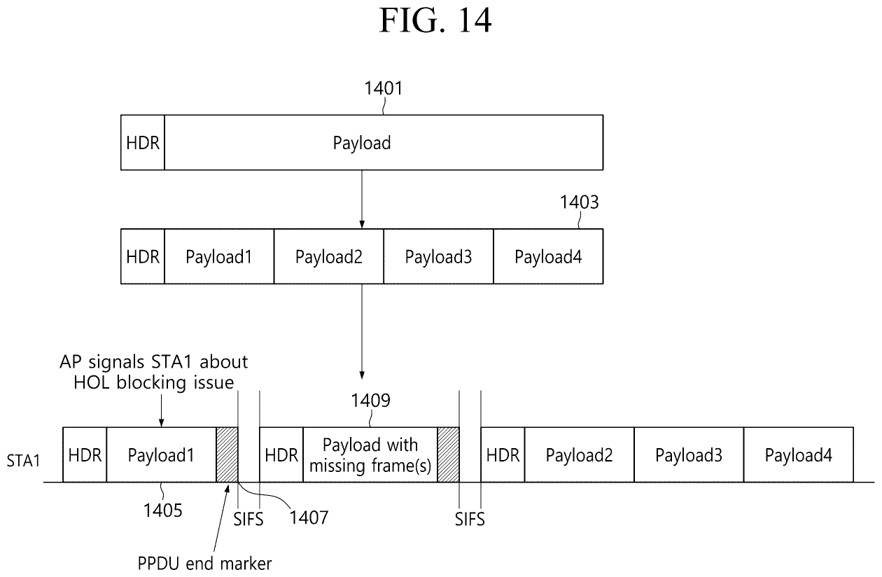

FIG. 14 illustrates missing frame payload insertion based on PPDU end marker in accordance with an embodiment. As illustrated, STA1 affiliated with a non-AP MLD may divide the payload of PPDU 1401 into four PPDU payloads 1403 that includes payload 1, payload 2, payload 3, and payload 4. At the indicated time 1405, STA1 affiliated with the non-AP MLD is signaled about the HOL blocking issue (e.g., the AP signals STA1 about the HOL blocking issue). Following this, the PHY layer of STA1 ends the transmission at the nearest boundary which is the boundary following payload 1 1407. STA1 inserts the payload including the missing frame(s) 1409 and transmits the payload including the missing frame(s) 1409 to the AP. After the payload transmission is over, the remaining payloads, payload 2, payload 3, and payload 4, are transmitted by STA1 to the AP.

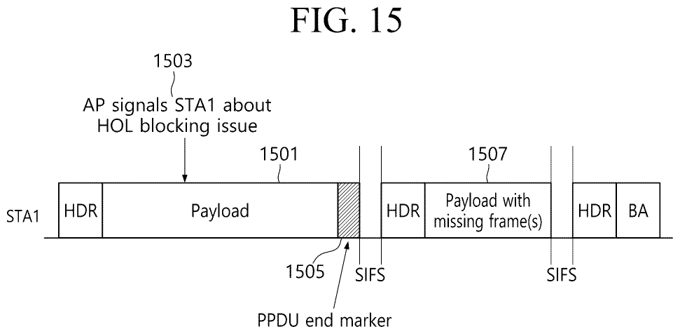

In some embodiments, the STA can allow the current PPDU transmission to complete and then insert the payload that includes the missing frame(s) following the Short Interframe Space (SIFS) duration. The AP can transmit a block-ACK (e.g., multi-TID block ACK) following the payload that includes the missing frame(s). The STA can insert a PPDU end marker following the current PPDU in order to indicate to the AP to change the AP's behavior to accommodate the upcoming payload that includes missing frame(s), as shown in FIG. 15 in accordance with an embodiment.

FIG. 15 illustrates missing frame payload transmission following the end of current payload transmission in accordance with an embodiment. As illustrated, there is a payload 1501. STA1 can receive a signal 1503 from AP about an HOL blocking issue. Following this, the PHY layer ends the transmission at the nearest boundary which is the PPDU end marker 1505 following payload 1503. The payload including the missing frame(s) 1507 is inserted. After the payload transmission is over, the remaining payloads are transmitted.

In some embodiments, the recovery procedure can be performed in an unrestricted manner (e.g., can be done by any device for any frame belonging to any TID).

In some embodiments, there can be a negotiation procedure that can indicate the use of the above procedures.

For example, suppose that a non-AP MLD wants to make use of this feature to enhance its latency and reduce the HOL blocking issue. The non-AP MLD can transmit a frame that includes a request message to the AP MLD.

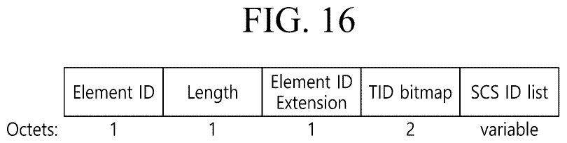

FIG. 16 illustrates a negotiation request element frame format in accordance with an embodiment. The negotiation request element frame format can include an element ID field, a length field, an element ID extension field, a TID bitmap field, and an SCS ID list field.

The element ID field can include an identifier of the element. The length field can include a length of the element. The element ID extension field can include an element ID extension of the element. The TID bitmap field can indicate the TIDs for which the HOL blocking procedures can be activated. A value of 1 at bit position k of the TID bitmap indicates that transmitter is requesting the HOL blocking related procedures be used for TID k. A value of 0 at bit position k of the TID bitmap indicates that transmitter is not requesting for HOL blocking related procedures to be used for TID k. The SCS ID list field can be a list of SCS IDs for which the procedures can be activated. For example, if a frame belonging to the indicated stream is facing a HOL blocking issue then the necessary signaling to ameliorate the issue for that packet. The above two fields can be interpreted independently e.g., as two different criteria which can both be applied independently. In some embodiments, they can be viewed as dependent parameters. For example, if a frame belonging to the indicated stream is facing HOL blocking issue and it is mapped to one of the TIDs indicated in the TID bitmap, then the necessary procedures can be used.

In some embodiments, the response frame can include the same fields as FIG. 16 with an additional field that can indicate the status code of the request.

In some embodiments, the negotiation request frame can include at least one or more of the information items as indicated in Table 3.

TABLE 3

| Information items | Description |
|---|---|
| TID information | An information item that can indicate the TID(s) for which the |
| | procedures ameliorating the HOL blocking are being requested to be |
| | used. e.g., a TID bitmap. If a frame that belongs to these TID(s) is |
| | facing an HOL blocking issue then the procedures can be used. |
| Reason code | An information item that can indicate the reason for sending the |
| | request. |
| SCS ID information | An information item that can indicate the SCS ID for which the |
| | procedures ameliorating the HOL blocking are being requested to be |
| | used. e.g., SCS ID list. For instance, when a frame belonging to one |
| | of these streams faces a HOL blocking issue, the signaling and |
| | missing frame(s) transmission procedure can be used. |
| Link information | An information item that can indicate the link(s) for which the |
| | procedures ameliorating the HOL blocking are being requested to be |
| | used. e.g., link ID bitmap. |
| Procedure activation | An information item indicating that the necessary procedures be |
| request | activated for the transmitter. e.g., a bit that can be set to 1 by non-AP |
| | MLD to indicate to AP MLD to activate the procedures and vice |
| | versa |
| Condition | An information item to indicate when the procedures can be |
| information | activated. e.g., a code to indicate that they can be activated all the |
| | time, upon dynamic indication by the STA to the AP, when channel |
| | congestion is detected, among others. In some embodiments, this can |
| | also be a negotiated timeout value that can be used to trigger the |
| | procedures. If the receiver sees that the sequence number hole is not |
| | filled by the timeout, then it can trigger the procedures. |
| Requirement type | An information item that can indicate if the requirement is a soft |
| | requirement (e.g., can be followed when possible by receiver |
| | implementation) or a hard requirement (e.g., must be followed by the |
| | receiver). |
| Duration | An information item that can indicate the duration for which the |
| | negotiation can be considered as valid. After this time, there may |
| | need to be a re-negotiation unless the existing one is refreshed. |

One or more of the above information item(s) can be carried in newly defined frames/elements or can be a part of any of the frames/elements existing in the standard.

In some embodiments, an AP can send a negotiation response that includes at least one or more of the information items as indicated in Table 4.

TABLE 4

| Information items | Description |
|---|---|
| TID information | An information item that can indicate the TID(s) for which the |
| | procedures ameliorating the HOL blocking are being granted to be |
| | used. e.g., a TID bitmap. If a frame that belongs to these TID(s) is |
| | facing an HOL blocking issue then the procedures can be used. |
| Reason code | An information item that can indicate the reason for sending the |
| | response. |
| Status code | An information item indicating the status of the request. e.g., success. |
| SCS ID information | An information item that can indicate the SCS ID for which the |
| | procedures ameliorating the HOL blocking are being granted to be |
| | used. e.g., SCS ID list. For instance, when a frame belonging to one |
| | of these streams faces a HOL blocking issue, the signaling and |
| | missing frame(s) transmission procedure can be used. |
| Link information | An information item that can indicate the link(s) for which the |
| | procedures ameliorating the HOL blocking are being granted to be |
| | used. e.g., link ID bitmap. |
| Procedure activation | An information item indicating that the necessary procedures will be |
| request | activated for the transmitter. e.g., a bit that can be set to 1 by AP |
| | MLD to indicate to the non-AP MLD to indicate that the necessary |
| | procedures are being activated. |
| Condition | An information item to indicate when the procedures can be |
| information | activated. e.g., a code to indicate that they can be activated all the |
| | time, upon dynamic indication by the STA to the AP, when channel |
| | congestion is detected, among others. In some embodiments, this can |
| | also be a negotiated timeout value that can be used to trigger the |
| | procedures. If the receiver sees that the sequence number hole is not |
| | filled by the timeout, then it can trigger the procedures. |
| Duration | An information item that can indicate the duration for which the |
| | negotiation can be considered as valid. After this time, there may |
| | need to be a re-negotiation unless the existing one is refreshed. |

One or more of the above information item(s) can be carried in newly defined frames/elements or can be a part of any of the frames/elements existing in the standard.

In some embodiments, one or more of the information items indicated in Table 3 and 4 can be present in an action frame(s) or an independent negotiation request and response frame(s)

In some embodiments, the STA can do the negotiation as a part of the SCS request and response procedure. The SCS request and response procedures can include a necessary indication (e.g., include the element described herein) for performing the negotiation.

If a frame belonging to a particular stream (e.g., as identified based on classification criteria such as that specified using the TCLAS element(s) and when necessary TCLAS processing element) faces a HOL blocking issue, then the AP MLD can use the procedures when necessary (e.g., if the AP MLD feels that the delay requirement can get exceeded, based on an indication from the non-AP MLD side).

In some embodiments, the STA can do the negotiation as a part of the association process. For example, via the (Re) association request frame and response frame.

In some embodiments, the negotiation can also be done independently as a new type of negotiation procedure. For example, by using the request and response elements inside new action frames.

In some embodiments, the transmitter can indicate if the HOL blocking issue needs to be addressed for a given transmission. The indication can be given as a part of the transmission itself. For example, there can be an information item in a transmission that can indicate if the receiver can treat the HOL blocking issue for any of the frames in the transmission upon facing a HOL blocking issue.

In some embodiments, the information item making the indication can be included in the MAC header of a transmission in the form of a bit that can be set to 1 if the transmitter wants the receiver to invoke a necessary procedure to ameliorate the HOL blocking issue if faced by any of the frames included in the transmission.

In some embodiments, there can be a control sub-field variant of an A-control subfield that can carry the indication.

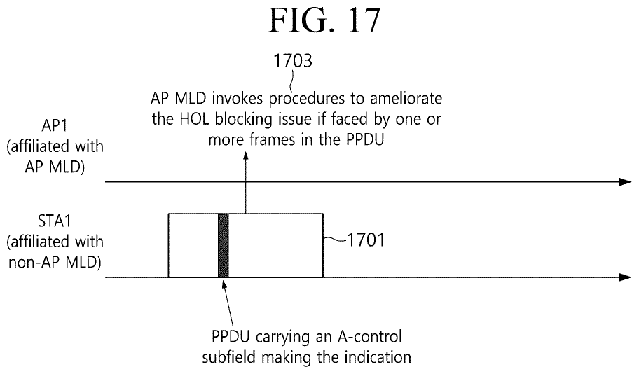

FIG. 17 illustrates an indication via an A-control subfield in accordance with an embodiment. In particular, FIG. 17 illustrates communication between AP1 And STA1. The PPDU carrying an A-control subfield 1701 can include link ID information to indicate which link the indication corresponds to. As illustrated, upon receiving such an indication from the non-AP MLD (e.g., from STA1), the AP MLD can invoke a necessary procedure 1703 to ameliorate the HOL blocking issue if faced by any of the frames included in the transmission.

In some embodiments, the receiver can invoke the procedure to ameliorate the HOL blocking issue in an unsolicited manner. The receiver can indicate to one or more transmitters in a frame transmitted to the transmitters. This frame can be a management frame such as a beacon which can carry an indication of which non-AP MLDs the AP MLD plans to invoke the procedures to ameliorate the HOL blocking issues for when needed. In some embodiments, this can also be a newly defined frame such as a new action frame.

In some embodiments, the receiver can determine the HOL blocking issue based on one or more criteria. The criteria can include but not be limited to the QoS requirements of individual non-AP MLDs.

In some embodiments, the AP MLD and non-AP MLD can advertise the capability to support the procedures described herein by making an indication in one or more frames that they transmit such as management frame(s), among others. In some embodiments, there can be a field inside the beacon that can indicate if an AP MLD can support these procedures. There can be a field in the probe request/(Re) association request frame that can indicate if the non-AP MLD can support these procedures and any necessary responses to the AP MLD side actions.

In some embodiments, the HOL blocking issue can be addressed by allowing an out of order delivery. In some embodiments, even if there is a hole in the sequence number, the hole can be ignored and the remaining frames can be transmitted to the upper layers.

In some embodiments, the receiver can pass the frames out of order and depend on the higher layer protocols (e.g., TCP) to do the missing frame retrieval. In some embodiments, the receiver can make an indication to the transmitter that the hole has been ignored and the frames have been passed to the upper layers. This indication can be made through one or more frames that the receiver transmits to the transmitter. In some embodiments, an indication can be made via an acknowledgement such as a block ACK frame that the receiver sends to the transmitter. The block ACK can include a one-bit field that can be set to 1 to indicate that the receiver has ignored the hole and passed the frames to higher layers. Upon receiving such an indication from the receiver, the transmitter can move on to the next set of frames in the transmit queue instead of retransmitting the frames.

In some embodiments, the receiver can indicate that it has received all the frames even though some frames were missing. Thus, the receiver can make the transmitter move to the next set of frames in the transmit queue.

In some embodiments, the receiver may not make such an indication and the transmitter can retransmit the lost frames as indicated in the acknowledgement frame (e.g., Block ACK) transmitted by the receiver to the transmitter. The transmitter can either pass these frame to a higher layer and allow the higher layer to handle the reordering. In some embodiments, the transmitter can drop the frames altogether and allow the higher layer to retrieve the lost frames via higher layer protocols.

In some embodiments, the out of order delivery can be performed for every received frame.

In some embodiments, there can be a negotiation procedure to determine which frame(s) the out of order delivery solution can be used to avoid HOL blocking issue. In some embodiments, there can be an exchange of negotiation request and response frames to make the decision. For example, the transmitter can send a request frame to the receiver and the receiver can transmit a response frame to the transmitter. The request and response frames can include at least one or more of the information items as indicated in Table 3 and 4. The signaling described for negotiation can be used for negotiation protocol for out of order delivery and the related procedures described herein can apply here as well.

In some embodiments, the transmitter can indicate if out of order delivery can be performed for a given transmission. The indication can be given as a part of the transmission itself. In some embodiments, there can be an information item in a transmission that can indicate if the receiver can perform out of order delivery for any of the frames in the transmission upon facing a HOL blocking issue.

In some embodiments, the information item making the indication can be included in the MAC header of a transmission in the form of a bit that can be set to 1 if the transmitter wants the receiver to ameliorate the HOL blocking issue if faced by any of the frames included in the transmission by performing out of order delivery.

In some embodiments, there can be a control sub-field variant of an A-control subfield that can carry the indication as depicted in FIG. 17. The A-control subfield can indicate if the transmitter can perform an out of order delivery if for instance a HOL blocking issue is faced by any of the frames in the transmission. The A-control subfield can include a link ID information to indicate which link the indication corresponds to.

Upon receiving such an indication from the receiver, the transmitter can perform out of order delivery.

In some embodiments, the receiver can invoke out of order delivery to ameliorate the HOL blocking issue in an unsolicited manner. The receiver can indicate to one or more transmitters in a frame transmitted to the transmitters. This frame can be a management frame such as a beacon which can carry an indication of which non-AP MLDs the AP MLD plans to invoke the procedures to ameliorate the HOL blocking issues for when needed. In some embodiments, the frame can be a newly defined frame such as a new action frame.

In some embodiments, the receiver can determine whether to invoke out of order delivery based on one or more criteria. The criteria can include but not be limited to the QoS requirements of individual non-AP MLDs.

In some embodiments, the receiver can consider the real time delay if available for the frame(s) (e.g., based on timing information indication as done for traffic urgency assessment) that are getting affected by the hole to determine if it can perform an out of order delivery or not. If the delay is above a certain threshold, then the receiver can perform out of order delivery for the frame(s).

In some embodiments, the receiver can check which stream the frame(s) belongs to and can perform out of order delivery if it belongs to a stream for which the out of order delivery needs to be performed to meet the stream's QoS requirements. Such streams can also be indicated by the transmitter when it performs SCS request and response procedure by including an information item in the request to indicate that out of order delivery can be performed for that particular stream.

In some embodiments, AP MLD and non-AP MLD can advertise the capability to support the procedures described herein by making an indication in one or more frames that they transmit such as management frame(s). In some embodiments, there can be a field inside the beacon that can indicate if an AP MLD can support these procedures. There can be a field in the probe request/(Re) association request frame that can indicate if the non-AP MLD can support these procedures and any necessary responses to the AP MLD side actions.

As described herein, IEEE 802.11 is designed to deliver frames in-order. In order to ensure that the frames are delivered in-order, the frames received are held in a reorder buffer at the receiver and then passed to the higher layer after all the frames in the same traffic category (e.g., TID) are received correctly. However, this in-order delivery approach can cause an issue if two or more applications have traffic that is mapped to the same traffic category (e.g., TID). An example of the problem can be described as follows.

Suppose that two or more applications have traffic that gets mapped to the same TID. Suppose that one or more of these applications have a very low latency requirement (e.g., on the order of a few milliseconds as described above). It is possible that when the very low latency application's frames are received and entered into the packet reorder buffer, there can be some hole(s) due to missing frames in the same TID that belong to the different application. As a result of these hole(s), the frame of the very low latency application can get delayed even though it is received at the receiver side. This can hurt the application performance. In order to ensure that such a problem does not degrade an application's performance, an out of order delivery approach can be taken. However, if the MAC performs an out of order delivery for every received frame, this can make the 802.11 MAC unreliable. Therefore, the MAC can selectively perform out of order delivery depending on the need.

Accordingly, many embodiments provide procedures which can indicate when and for which frames out of order delivery can be performed.

In some embodiments, a negotiation based procedure can be followed for setting up out of order delivery procedure. In some embodiments, a requesting entity (e.g., an STA) can send a request message to an authorizing entity (e.g., an AP).

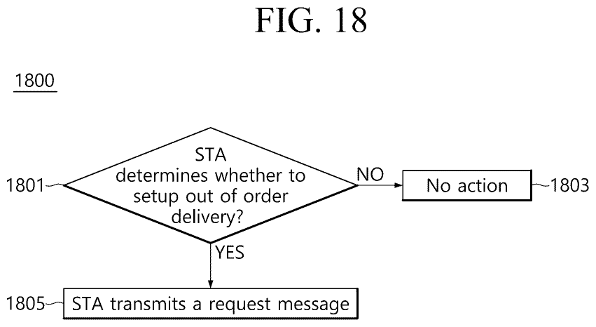

FIG. 18 illustrates a flow chart of an example process for request message transmission in accordance with an embodiment. For explanatory and illustration purposes, the example process 1800 may be performed by the STA depicted in FIGS. 1 and 3. Although one or more operations are described or shown in particular sequential order, in other embodiments the operations may be rearranged in a different order, which may include performance of multiple operations in at least partially overlapping time periods.

In operation 1801, the STA determines whether it wants to setup out of order delivery. If the STA determines that it does not want to setup out of order delivery, the process performs operation 1803 where no action is performed. If the STA determines that it wants to setup out of order delivery, the process performs operation 1805 where the STA can transmit a request message.

The authorizing entity can process the request message and can generate a response message and transmit it to the requesting entity.

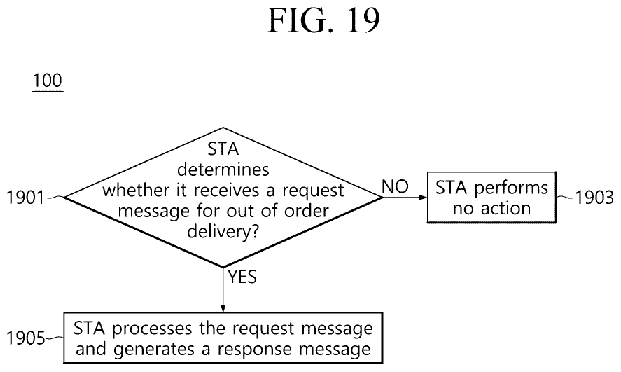

FIG. 19 illustrates a flow chart of a process for response message transmission in accordance with an embodiment. For explanatory and illustration purposes, the example process 1900 may be performed by the STA depicted in FIGS. 1 and 3. Although one or more operations are described or shown in particular sequential order, in other embodiments the operations may be rearranged in a different order, which may include performance of multiple operations in at least partially overlapping time periods.

In operation 1901, the STA determines whether it receives a request message for out of order delivery. If the STA does not receive a request message, the processes perform operation 1903 where no action is performed. If the STA does receive a request message for out of order delivery, the process proceeds to operation 1905 where the STA can process the request message and generate a response message.

The request message can include at least one or more of the information items as indicated in Table 5.

TABLE 5

| Information item | Description |
|---|---|
| Classification | An information item that can describe the classification criteria to identify |
| criteria | the frames which can be delivered out of order at the receiver side. e.g., |
| | TCLAS element, TCLAS processing element. |
| Traffic | An information item that can describe the traffic identifier(s) for the |
| identifier | frames which can be delivered out of order at the receiver side. e.g., TID |
| | indication based on a TID bitmap. |
| Stream | An information item that can describe the stream identifier(s) for the |
| identifier | frames which can be delivered out of order at the receiver side. e.g., SCS |
| | ID(s). |
| Duration | An information item that can describe the duration for which the |
| information | negotiation holds good. After this time, the negotiation may need to be |
| | performed again. e.g., an expiration timer expressed in terms of TBTT, |
| | TU, among others. |
| Requirement | An information item that can describe the out of order delivery |
| type | requirement for the indicated traffic. e.g., if it's a hard requirement and |
| | AP can perform out of order delivery for every frame of the category, if |
| | it's a soft requirement and AP can perform out of order delivery only |
| | when the delay tolerance of the frames can get exceeded due to in order |
| | delivery approach. |
| Response | An information item that can indicate to the authorizing entity if the |
| required | requesting entity expects a response message from it. If a response |
| | message is needed, then the authorizing entity can generate one otherwise |
| | it can skip the response message. |
| Request | An information item that can serve as a reference for the request message. |
| message | The authorizing entity use the same reference in the response message. |
| identifier | e.g., dialog token. |
| QoS | An information item that can describe the QoS requirement for the above |
| requirement | indicated traffic stream(s). e.g., delay tolerance. |
| Wait time | An information item that can describe if the receiver can wait for a certain |
| threshold | period of time for the holes to be recovered. If the holes are not recovered |
| | within this period, then the receiver can perform out of order delivery. |

The above information items can be transmitted together or separately. They can be transmitted as a part of an existing frame/element/field/subfield in the standard or can be a part of newly defined ones.

Upon receiving the request message, the requesting entity can generate a response message. The response message can include at least one or more of the information items as indicated in Table 6.

TABLE 6

| Information item | Description |
|---|---|
| Status | An information item that can indicate the status of the request made by |
| information | the requesting entity. e.g., status code. |
| Request | An information item that can indicate the request message identifier that |
| message | was used by the requesting entity. This can enable the requesting entity to |
| identifier | understand what request message the response message corresponds to. |
| | e.g., dialog token. |
| Duration | An information item that can describe the duration for which the |
| information | negotiation holds good. After this time, the negotiation may need to be |
| | performed again. e.g., an expiration timer expressed in terms of TBTT, |
| | TU, among others. |

The above information items can be transmitted together or separately. They can be transmitted as a part of any existing frame/element/field/subfield in the standard or can be a part of newly defined ones.

In some embodiments, the messages can be transmitted as a part of the SCS request and response frame exchanges.

In some embodiments, the authorizing entity (e.g., AP) can transmit an unsolicited authorization message to a device to authorize it for out of order delivery.

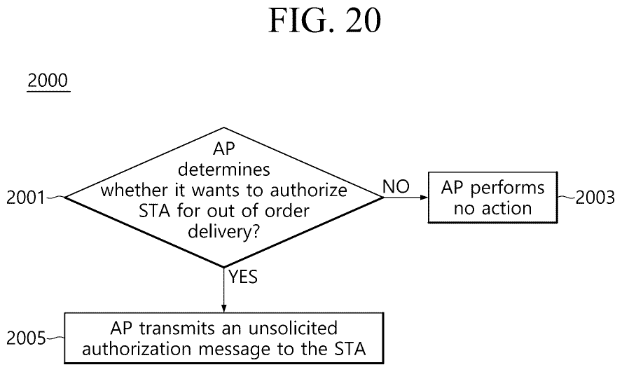

FIG. 20 illustrates a flow chart of an example process of unsolicited authorization message in accordance with an embodiment. For explanatory and illustration purposes, the example process 2000 may be performed by the AP depicted in FIGS. 1 and 3. Although one or more operations are described or shown in particular sequential order, in other embodiments the operations may be rearranged in a different order, which may include performance of multiple operations in at least partially overlapping time periods.

In operation 2001, the AP determines whether it wants to authorize an STA for out of order delivery. If the AP determines that it does not want to authorize an STA for out of order delivery, the process performs operation 2003 where no action is performed. If the AP determines that it does want to authorize an STA for out of order delivery, the process performs operation 2005 where the AP can transmit an unsolicited authorization message to the STA.

The unsolicited authorization message from the authorizing entity can include at least one or more of the information items as indicated in Table 7. For example, the authorizing entity may not be able to meet the device's QoS requirements without initiating an out of order delivery.

Table 7 provides information items that can be present in unsolicited authorization message.

TABLE 7

| Information item | Description |
|---|---|
| Traffic | An information item that can describe the traffic identifier(s) for the frames |
| identifier | which can be delivered out of order at the receiver side. e.g., TID indication |
| | based on a TID bitmap. |
| Stream | An information item that can describe the stream identifier(s) for the frames |
| identifier | which can be delivered out of order at the receiver side. e.g., SCS ID(s). |
| Duration | An information item that can describe the duration for which the |
| information | authorization holds good. e.g., an expiration timer expressed in terms of |
| | TBTT, TU, among others. |

The above information items can be transmitted together or separately. They can be transmitted as a part of any existing frame/element/field/subfield in the standard or can be a part of newly defined ones.

In some embodiments, an indication message can be provided as a part of the transmission itself.

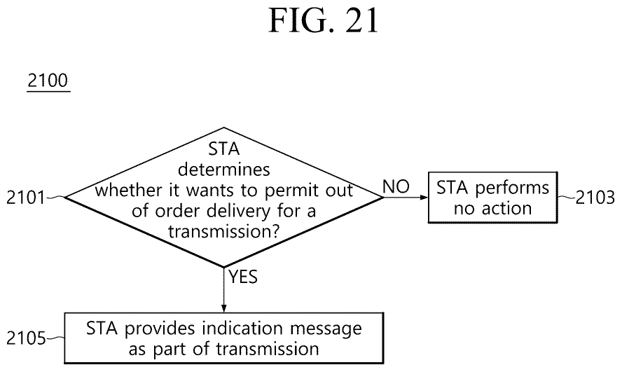

FIG. 21 illustrates a flow chart of a process for unsolicited indication message in accordance with an embodiment. For explanatory and illustration purposes, the example process 2100 may be performed by the STA depicted in FIGS. 1 and 3. Although one or more operations are described or shown in particular sequential order, in other embodiments the operations may be rearranged in a different order, which may include performance of multiple operations in at least partially overlapping time periods.

In operation 2101 the STA determines whether it wants to permit out of order delivery for a transmission. If the STA determines that it does not want to permit out of order delivery for a transmission, the process performs operation 2103 where no action is performed. If the STA determines that it does want to permit out of order delivery for a transmission, the process performs operation 2105 where the STA can provide an indication message as part of the transmission.

Upon receiving the indication message, the receiver can understand which frames in the current transmission can be delivered out of order and which ones need to be delivered in order. The indication message can include at least one or more of the information items as indicated in Table 8.

TABLE 8

| Information item | Description |
|---|---|
| Indication | An information item that can provide an indication that the frame(s) can be |
| | delivered out of order. e.g., a field (e.g., a bit) that can be set to a |
| | predetermined value (e.g., 1) if the frames can be delivered out of order. |
| Frame | An information item that can provide an indication of which frame(s) in |
| indication | the current transmission can be delivered out of order. e.g., a bitmap. |

The above information items can be transmitted together or separately. They can be transmitted as a part of any existing frame/element/field/subfield in the standard or can be a part of newly defined ones.

In some embodiment, a device that supports out of order delivery can advertise the support for the feature in one or more frames that it transmits.

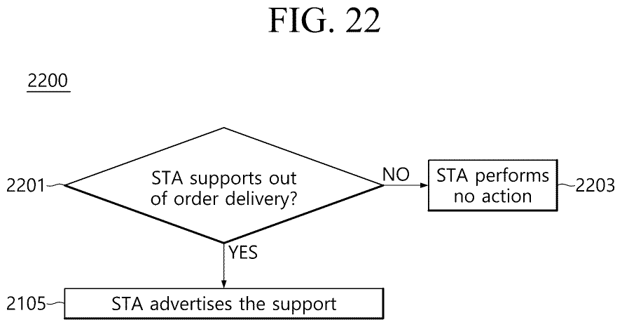

FIG. 22 illustrates a flow chart of a process of capability advertisement in accordance with an embodiment. In operation 2201, the STA determines whether it supports out of order delivery. If the STA determines that it does not support out of order delivery, the process performs operation 2203 where no action is performed. If the STA determines that it does support out of order delivery, the process performs operation 2205 where the STA can advertise the support.

In some embodiments, if the AP supports out of order delivery then it can advertise the support for the feature in management frames such as beacons, probe response, among others that it transmits. When a STA receives these frames it can understand the support for the feature on the AP side and can initiate procedures for out of order delivery.

In some embodiments, when the STA supports out of order delivery then it can advertise the support for the feature in one or more frames that it transmit, including for example, management frames such as probe requests, association requests, among others.

In some embodiments, a device that supports any of the procedures described in this disclosure can advertise the support for the procedure in one or more frames that they transmit. This can enable the requesting entity to understand what type of procedure can be followed when requesting or setting up out of order delivery with authorizing entity.

Even though the AP is mentioned as the authorizing entity and the STA is mentioned as the requesting entity in some of the embodiments, any device can be an authorizing entity and request entity.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first device associated with a second device in a wireless network, the first device comprising:
at least one station (STA) affiliated with the first device;
a processor coupled to the at least one STA, the processor configured to:
establish one or more links between the first device and the second device;
transmit one or more physical layer protocol data units (PPDUs) comprising a plurality of frames to the second device; and
receive a first frame from the second device that includes information on a second frame that is missing.

2. The first device of claim 1, wherein the STA is an access point (AP) STA or a non-AP STA.

3. The first device of claim 1, wherein the processor is further configured to transmit the second frame that is missing to the second device.

4. The first device of claim 1, wherein the processor is further configured to transmit a next set of frames in a transmit queue to the second device instead of retransmitting the second frame that is missing.

5. The first device of claim 3, wherein the first device comprises at least two STAs affiliated with the first device, and the processor is configured to establish at least two links between the first device and the second device.

6. The first device of claim 5, wherein the first frame is received on a first link between a first STA affiliated with the first device and a first STA affiliated with the second device and the second frame is transmitted on a second link between a second STA affiliated with the first device and a second STA affiliated with the second device.

7. The first device of claim 5, wherein the first frame and the second frame are received and transmitted on a same link.

8. The first device of claim 5, wherein the first frame and the second frame are received and transmitted on different links.

9. The first device of claim 3, wherein the second frame includes a field indicating a link identifier (ID) of a link for which the second frame corresponds to.

10. The first device of claim 1, wherein two or more PPDUs are separated by a first interframe space (IFS) that is longer than a short interframe space (SIFS).

11. A first device associated with a second device in a wireless network, the first device comprising:
at least one STA affiliated with the first device;
a processor coupled to the at least one STA, the processor configured to:
establish one or more links between the first device and the second device;
receive one or more physical layer protocol data units (PPDUs) comprising a plurality of frames from the second device; and
identify a first frame that is missing in the one or more PPDUs.

12. The first device of claim 11, wherein the STA is an access point (AP) STA or a non-AP STA.

13. The first device of claim 11, wherein the processor is further configured to transmit, to the second device, a second frame that includes information on the first frame that is missing in the one or more PPDUs.

14. The first device of claim 13, wherein the processor is further configured to receive the first frame from the second device.

15. The first device of claim 11, wherein the processor is further configured ignore the first frame and transmit the plurality of frames to an upper layer within the first device.

16. The first device of claim 14, wherein the first device comprises at least two STAs affiliated with the first device, and the processor is configured to establish at least two links between the first device and the second device.

17. The first device of claim 16, wherein the second frame is transmitted on a first link between a first STA affiliated with the first device and a first STA affiliated with the second device and the first frame is received on a second link between a second STA affiliated with the first device and a second STA affiliated with the second device.

18. The first device of claim 16, wherein the first frame and the second frame are received and transmitted on a same link.

19. The first device of claim 16, wherein the first frame and the second frame are received and transmitted on different links.

20. The first device of claim 11, wherein two or more PPDUs are separated by a first interframe space (IFS) that is longer than a short interframe space (SIFS).
